(19) United States
(12) Patent Application Publication
(10) Pub. No.: US 2012/0143927 A1
(43) Pub. Date: Jun. 7, 2012

(54) EFFICIENT STORAGE OF INFORMATION FROM MARKUP LANGUAGE DOCUMENTS

(75) Inventors: Michael J. Hill, Vadnais Heights, MN (US); John C. Horton, Saint Paul, MN (US)

(73) Assignee: Unisys Corp., Blue Bell, PA (US)

(21) Appl. No.: 12/960,510

(22) Filed: Dec. 5, 2010

(51) Int. Cl. G06F 17/30

(52) U.S. Cl. 707/825; 707/E17.01

(57) ABSTRACT

An in-memory document model may be created from a markup language document while parsing the markup language document. The model includes small fixed-size memory structures allocated from a single larger memory pool. The model stores the data contained in the markup language document and the hierarchical relationship between the data items in the markup language document. Thus, random access to the markup language document is achieved without further access to the document and without the overhead of language-specific object construction. When an object-oriented computer program instance references the document model, a language-specific object may be constructed from the model including a pointer to an element of the model. The document model may be created when parsing extensible markup language (XML) documents.

### TECHNICAL FIELD

The instant disclosure relates to computer programs. More specifically, the instant disclosure relates to processing markup language documents.

### BACKGROUND

When working with markup language documents in a computer program, navigating the document's tree structure is inefficient. Many application program interfaces (APIs) such as, for example, document object model (DOM) or ECMAScript for XML (E4X) support random access to open files. When accessing a markup language document, an application needs to have a count of the number of child nodes to a parent node before iterating through the child nodes. Counting nodes often involves accessing each of the child nodes. Reparsing the relevant portion of the source document as each child node is accessed is costly for the computer program.

In object-oriented programming environments such as, for example, JavaScript and C++ the parsed document may conventionally be represented as a collection of linked programming objects. That is, each node or node member such as, for example, attribute or text is addressed as a language-specific object. These objects are conventionally constructed as the document is parsed and before any reference is made by the application program to individual document nodes. While this approach facilitates efficient random access, it is also very likely that only a portion of the document nodes will actually be referenced by the computer application. The object creation overhead for the unreferenced nodes is wasted, which results in decreased application speed when loading files and increased resource usage.

### SUMMARY

According to one embodiment, a method includes reading a markup language document. The method also includes parsing the markup language document. The method further includes storing an in-memory document model of the markup language document.

According to another embodiment, a computer program product includes a computer-readable medium having code to read a markup language document. The medium also includes code to parse the markup language document. The medium further includes code to store an in-memory document model of the markup language document.

According to yet another embodiment, an apparatus includes a processor and a memory coupled to the processor, in which the processor is configured to read a markup language document from the memory. The process is also configured to parse the markup language document from the memory. The processor is further configured to store an in-memory document model of the markup language document.

The foregoing has outlined rather broadly the features and technical advantages of the present invention in order that the detailed description of the invention that follows may be better understood. Additional features and advantages of the invention will be described hereinafter which form the subject of the claims of the invention. It should be appreciated by those skilled in the art that the conception and specific embodiment disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims. The novel features which are believed to be characteristic of the invention, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present invention.

### BRIEF DESCRIPTION OF THE DRAWINGS

For a more complete understanding of the disclosed system and methods, reference is now made to the following descriptions taken in conjunction with the accompanying drawings.

FIG. 1 is a block diagram illustrating an information system according to one embodiment of the disclosure.

FIG. 2 is block diagram illustrating a data management system configured to store information from markup language documents according to one embodiment of the disclosure.

FIG. 3 is a block diagram illustrating a server according to one embodiment of the disclosure.

FIG. 4 is an exemplary script describing a data structure for nodes of a document according to one embodiment of the disclosure.

FIG. 5 is an exemplary script describing a data structure for a document model according to one embodiment of the disclosure.

FIG. 6 is a flow chart illustrating a method of modeling a markup language document according to one embodiment of the disclosure.

FIG. 7 is an exemplary sample extensible markup language (XML) document according to one embodiment of the disclosure.

FIG. 8 is a textual representation of the in-memory document model produced from the XML document illustrated in FIG. 7, with corresponding XML_ITEM numbers.

FIG. 9 is a relationship diagram illustrating a markup language document model according to one embodiment of the disclosure.

FIG. 10 is a block diagram illustrating accessing a node of the document model by an application program according to one embodiment.

### DETAILED DESCRIPTION

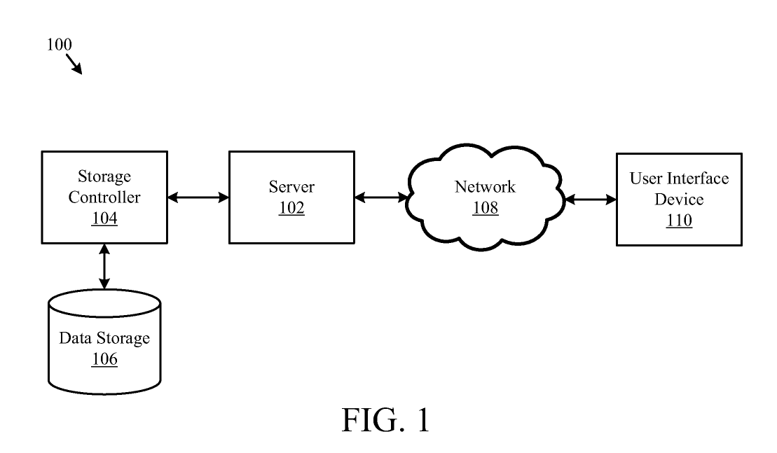

FIG. 1 illustrates one embodiment of a system 100 for an information system. The system 100 may include a server 102, a data storage device 106, a network 108, and a user interface device 110. In a further embodiment, the system 100 may include a storage controller 104, or storage server configured to manage data communications between the data storage device 106, and the server 102 or other components in communication with the network 108. In an alternative embodiment, the storage controller 104 may be coupled to the network 108.

In one embodiment, the user interface device 110 is referred to broadly and is intended to encompass a suitable processor-based device such as a desktop computer, a laptop computer, a personal digital assistant (PDA) or table computer, a smartphone or other a mobile communication device or organizer device having access to the network 108. In a further embodiment, the user interface device 110 may access the Internet or other wide area or local area network to access a web application or web service hosted by the server 102 and provide a user interface for enabling a user to enter or receive information such as a count request.

The network 108 may facilitate communications of data between the server 102 and the user interface device 110. The network 108 may include any type of communications network including, but not limited to, a direct PC-to-PC connection, a local area network (LAN), a wide area network (WAN), a modem-to-modem connection, the Internet, a combination of the above, or any other communications network now known or later developed within the networking arts which permits two or more computers to communicate, one with another.

In one embodiment, the user interface device 110 access the server 102 through an intermediate sever (not shown). For example, in a cloud application the user interface device 110 may access an application server. The application server fulfills requests from the user interface device 110 by accessing a database management system (DBMS). In this embodiment, the user interface device 110 may be a computer executing a Java application making requests to a JBOSS server executing on a Linux server, which fulfills the requests by accessing a relational database management system (RDMS) on a mainframe server.

In one embodiment, the server 102 is configured to store databases, pages, tables, and/or records. Additionally, scripts on the server 102 may access data stored in the data storage device 106 via a Storage Area Network (SAN) connection, a LAN, a data bus, or the like. The data storage device 106 may include a hard disk, including hard disks arranged in an Redundant Array of Independent Disks (RAID) array, a tape storage drive comprising a physical or virtual magnetic tape data storage device, an optical storage device, or the like. The data may be arranged in a database and accessible through Structured Query Language (SQL) queries, or other data base query languages or operations.

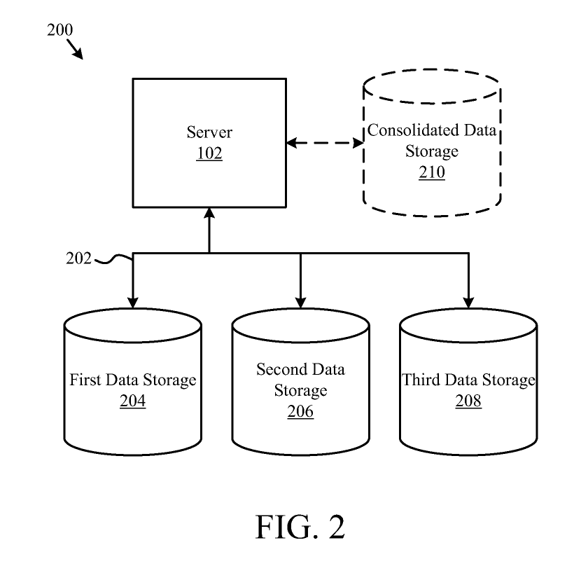

FIG. 2 illustrates one embodiment of a data management system 200 configured to provide access to markup language documents. In one embodiment, the data management system 200 may include a server 102. The server 102 may be coupled to a data-bus 202. In one embodiment, the data management system 200 may also include a first data storage device 204, a second data storage device 206, and/or a third data storage device 208. In further embodiments, the data management system 200 may include additional data storage devices (not shown). In such an embodiment, each data storage device 204, 206, 208 may each host a separate database that may, in conjunction with the other databases, contain redundant data. Alternatively, a database may be spread across storage devices 204, 206, 208 using database partitioning or another mechanism. Alternatively, the storage devices 204, 206, 208 may be arranged in a RAID configuration for storing a database or databases and may contain redundant data.

In one embodiment, the server 102 may submit a query to selected data from the storage devices 204, 206. The server 102 may store consolidated data sets in a consolidated data storage device 210. In such an embodiment, the server 102 may refer back to the consolidated data storage device 210 to obtain nodes of a markup language document. Alternatively, the server 102 may query each of the data storage devices 204, 206, 208 independently or in a distributed query to obtain the set of data elements. In another alternative embodiment, multiple databases may be stored on a single consolidated data storage device 210.

In various embodiments, the server 102 may communicate with the data storage devices 204, 206, 208 over the data-bus 202. The data-bus 202 may comprise a SAN, a LAN, or the like. The communication infrastructure may include Ethernet, Fibre-Chanel Arbitrated Loop (FC-AL), Fibre-Channel over Ethernet (FCoE), Small Computer System Interface (SCSI), Internet Small Computer System Interface (iSCSI), Serial Advanced Technology Attachment (SATA), Advanced Technology Attachment (ATA), cloud attached storage, and/or other similar data communication schemes associated with data storage and communication. For example, the server 102 may communicate indirectly with the data storage devices 204, 206, 208, 210; the server 102 first communicating with a storage server or the storage controller 104.

The server 102 may include modules for interfacing with the data storage devices 204, 206, 208, 210, interfacing a network 108, interfacing with a user through the user interface device 110, and the like. In a further embodiment, the server 102 may host an engine, application plug-in, or application programming interface (API).

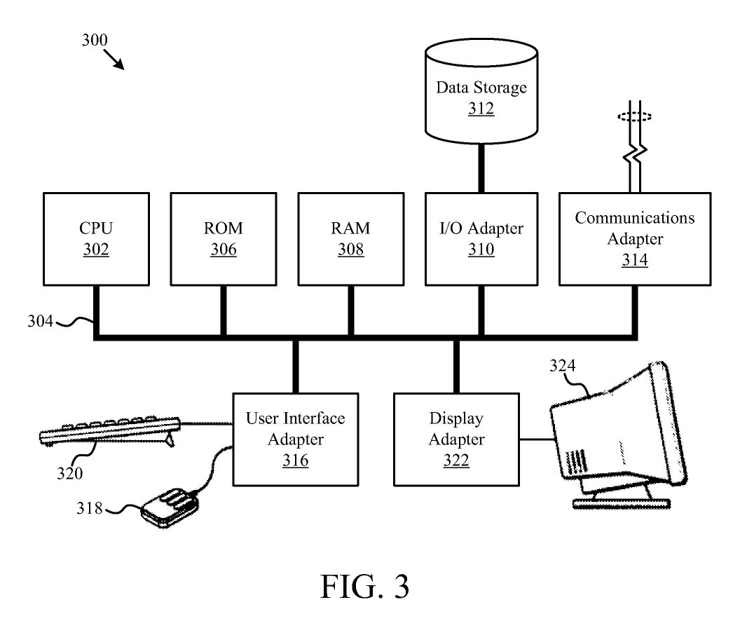

FIG. 3 illustrates a computer system 300 adapted according to certain embodiments of the server 102 and/or the user interface device 110. The central processing unit (“CPU”) 302 is coupled to the system bus 304. The CPU 302 may be a general purpose CPU or microprocessor, graphics processing unit (“GPU”), microcontroller, or the like. The present embodiments are not restricted by the architecture of the CPU 302 so long as the CPU 302, whether directly or indirectly, supports the modules and operations as described herein. The CPU 302 may execute the various logical instructions according to the present embodiments.

The computer system 300 also may include random access memory (RAM) 308, which may be SRAM, DRAM, SDRAM, or the like. The computer system 300 may utilize RAM 308 to store the various data structures used by a software application such as markup language documents. The computer system 300 may also include read only memory (ROM) 306 which may be PROM, EPROM, EEPROM, optical storage, or the like. The ROM may store configuration information for booting the computer system 300. The RAM 308 and the ROM 306 hold user and system data.

The computer system 300 may also include an input/output (I/O) adapter 310, a communications adapter 314, a user interface adapter 316, and a display adapter 322. The I/O adapter 310 and/or the user interface adapter 316 may, in certain embodiments, enable a user to interact with the computer system 300. In a further embodiment, the display adapter 322 may display a graphical user interface associated with a software or web-based application. For example, the display adapter 322 may display menus allowing an administrator to input data on the server 102 through the user interface adapter 316.

The I/O adapter 310 may connect one or more storage devices 312, such as one or more of a hard drive, a compact disk (CD) drive, a floppy disk drive, and a tape drive, to the computer system 300. The communications adapter 314 may be adapted to couple the computer system 300 to the network 108, which may be one or more of a LAN, WAN, and/or the Internet. The communications adapter 314 may be adapted to couple the computer system 300 to a storage device 312. The user interface adapter 316 couples user input devices, such as a keyboard 320 and a pointing device 318, to the computer system 300. The display adapter 322 may be driven by the CPU 302 to control the display on the display device 324.

The applications of the present disclosure are not limited to the architecture of computer system 300. Rather the computer system 300 is provided as an example of one type of computing device that may be adapted to perform the functions of a server 102 and/or the user interface device 110. For example, any suitable processor-based device may be utilized including, without limitation, personal data assistants (PDAs), tablet computers, smartphones, computer game consoles, and multi-processor servers. Moreover, the systems and methods of the present disclosure may be implemented on application specific integrated circuits (ASIC), very large scale integrated (VLSI) circuits, or other circuitry. In fact, persons of ordinary skill in the art may utilize any number of suitable structures capable of executing logical operations according to the described embodiments.

According to one embodiment, an in-memory document model may be created from a markup language document while parsing the markup language document to allow efficient random access in a computer program. The model may include small fixed-size memory structures allocated from a single larger memory pool. The model may include the data contained in the markup language document and the hierarchical relationship between the data items in the markup language document. Thus, after initially parsing the markup language document random access to the data of the markup language document is allowed without additional accesses to the file. Additionally, the overhead of proactive language-specific object construction is avoided. When an object-oriented computer program instance references the document model, a language-specific object may be constructed from the model including pointer to an element of the model.

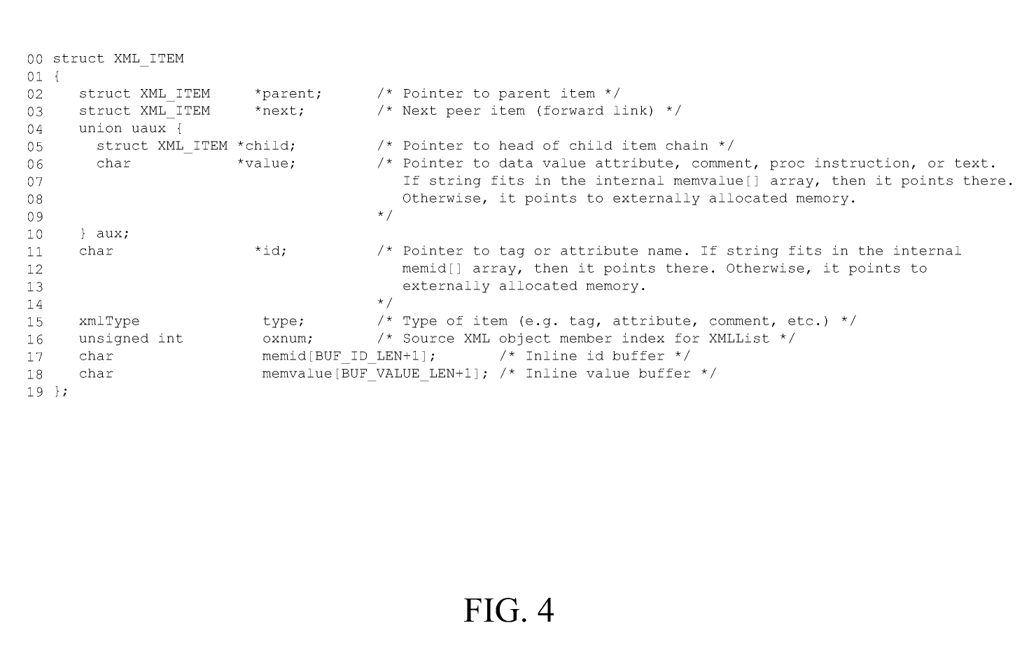

FIG. 4 is an exemplary script describing a data structure for nodes of a document according to one embodiment of the disclosure. A data structure for modeling each node of a markup language document is illustrated in the structure named XML_ITEM beginning on line 1. The XML_ITEM data structure may include a pointer to a parent item, to a next (peer) item, to the head of a child item chain, to a data value, and to a tag or attribute name, and an item type indicator. The type member illustrated on line 15 may indicate a kind of XML component data being represented. The id member illustrated on line 11 may be used with memid for xmlAttribute, xmlPI, and xmlTag string data (name). The embodiment may also include an xmlNamespace type along with other data structure members to fully support XML documents that contain namespaces, but these are not described. The uaux union on line 4 may be interpreted based on the value for type where the child union member is used for xmlTag type, the value union member may be used with memvalue for xmlAttribute, xmlComment, xmlPI, and xmlText string data (value) The oxnum member on line 16 may indicate when an XML_ITEM has an associated implicit XML item.

Because markup language node string data lengths may be unknown and variable, an estimate of a string length that will accommodate the majority of items found in document nodes is used when allocating memory space to the data structure. According to one embodiment, if a node string exceeds this length the model node item structure may point to a memory area outside the structure that contains the longer string data item. Otherwise, if the node string is less than the estimated length, the string data may be stored within the node.

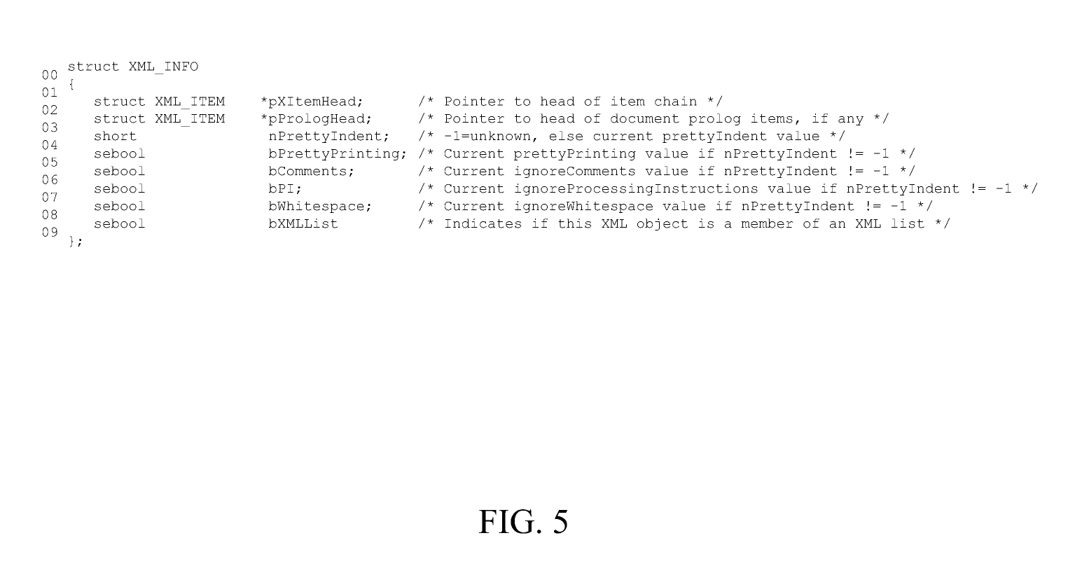

FIG. 5 is an exemplary script describing a data structure for a document model according to one embodiment of the disclosure. A data structure for representing the head of each in-memory document is illustrated in the structure model named XML_INFO beginning on line 1. The XML_INFO data structure may include pointers to a head of an item chain and a head of document prolog items, as well as document-level properties as illustrated by a prettyPrinting value, a ignoreComments value, an ignoreProcessingInstructions value, and an ignoreWhitespace value. The pXltemHead member on line 2 may be a pointer to the XML document root XML_ITEM. The pPrologHead member on line 3 may be a pointer to the first xmlComment or xmlPI prolog XML_ITEM. The bXMLList property may be used to distinguish if this XML_INFO was created explicitly to satisfy an application XML object reference rather than implicitly during the initial XML document parsing. This is used during cleanup processing as describe below.

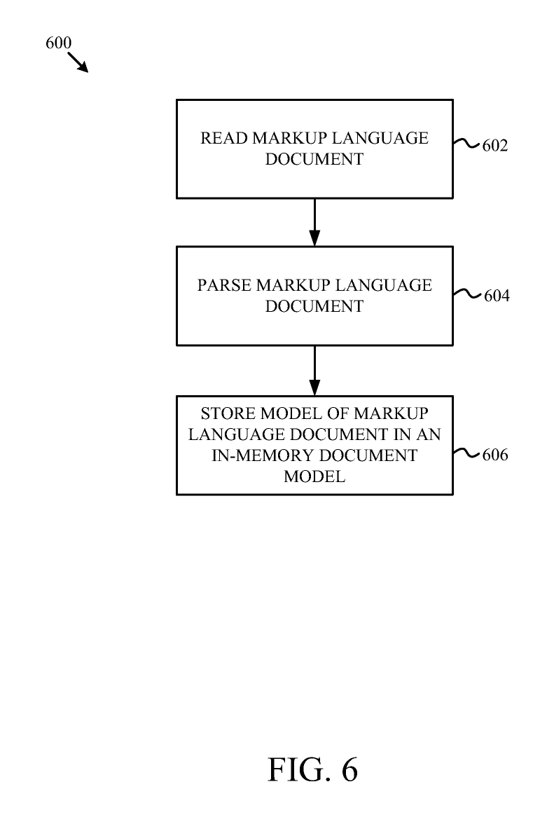

FIG. 6 is a flow chart illustrating a method of modeling a markup language document according to one embodiment of the disclosure. At block 602 a markup language document is read. At block 604 the markup language document is parsed. A parser may provide a number of event driven callback functions, which invoke handlers as various tags, character data, and comments are encountered in a markup language document. The handlers may create a linked list of XML_ITEM structures to indicate the specific XML data items in a manner that reflects their ordering in the XML markup document. Two linked XML_ITEM lists may be created: one list for the prolog XML data, if any, and another list for the XML document contained between start and end root tags of the XML document. According to one embodiment, these lists may be kept in the XML object's hidden XML_INFO structure (pPrologHead and pXltemHead).

At block 606 a model of the markup language document is stored in an in-memory document model. Each XML_ITEM may represent a specific attribute, comment, namespace declaration, processing instruction, tag or text component within the XML document. The XML_ITEM may link its relationship with the other components in the document. The creation of separate “implicit” XML objects may be deferred until they are needed to populate the returned XMLList objects as a result of explicit references to an XML object by the application. Each referenced XML_ITEM may contain a hidden identifier (oxnum) to its implicit XML object to prevent the creation of unnecessary duplicate implicit objects.

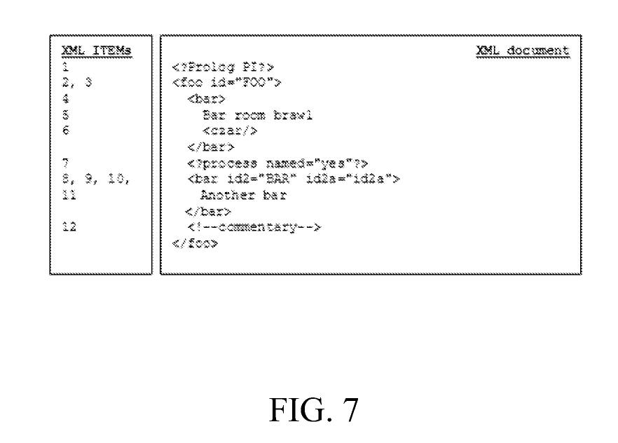

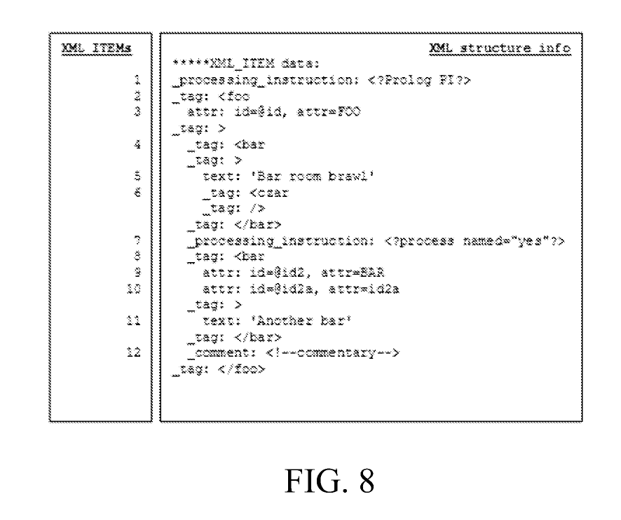

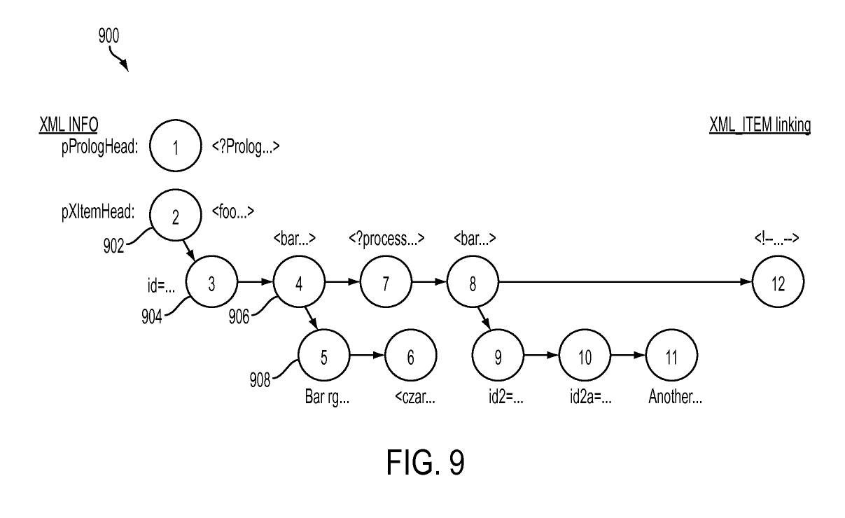

An example markup language document is illustrated in FIG. 7. FIG. 7 is an exemplary sample extensible markup language (XML) document according to one embodiment of the disclosure. XML item numbers assigned to each of the rows of the XML document to indicate a position in a document model assigned to elements of that row of the XML document. FIG. 8 is a textual representation of the in-memory document model produced from the XML document illustrated in FIG. 7, with corresponding XML_ITEM numbers. A relationship diagram of the document model representing the markup language document is illustrated in FIG. 9. Although XML markup documents are illustrated in FIGS. 7-9 the document model and method of forming the document model may be applied to a hypertext markup language (HTML) document, an extensible hypertext markup language document (XHTML), or other markup language documents. According to one embodiment, XML namespace syntax may be supported by the markup language document parser.

FIG. 9 is a block diagram illustrating a markup language document model according to one embodiment of the disclosure. The node numbers of a tree 900 indicate the corresponding elements of the markup language document of FIG. 7. For example, a node 902 includes the “foo” tag and a node 904 includes an id element of the “foo” tag. Additionally, a node 906 includes the subtag “bar”. Data of the subtag “bar” may be stored in a node 908. The tree 900 may be completed with additional nodes as the markup language document is processed.

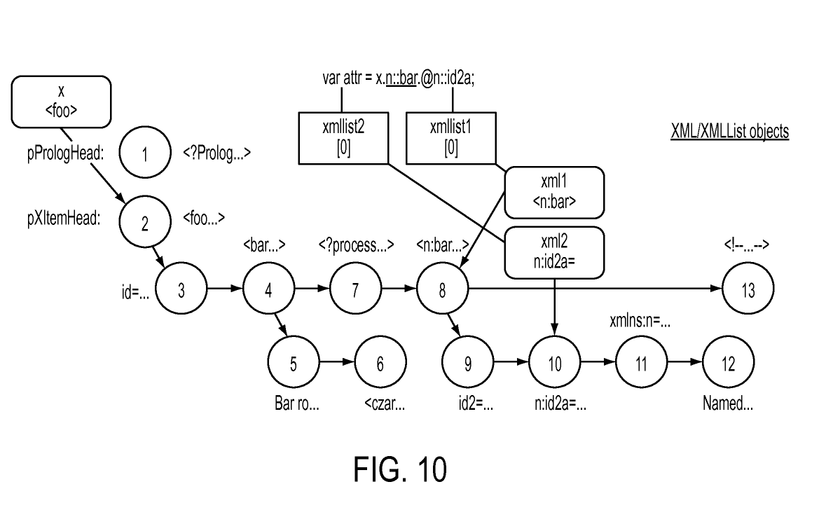

FIG. 10 is a block diagram illustrating accessing a node of the document model by an application program according to one embodiment. The XML_ITEM linking for FIG. 10 is similar to that for the XML document shown in FIG. 9 except that the second <bar> child member at node number 8 includes namespace “n”, <n:bar> and node number 11 represents the xmlNamespace declaration for namespace “n”. Note that child attribute id2a at node number 10 also uses namespace “n”. The XML document may be accessed through the in-memory model with a statement such as E4X “var attr=x.n::bar.@n::id2a,” which obtains a reference to the “n:id2a” attribute within <n:bar>. When this access is performed the “x.n::bar” portion of the statement causes an XMLList object xmllist1 to be created with bXMLList set true and member [0] xml1, which is an implicitly created XML object that refers to XML_ITEM #8 in the source XML_ITEM list. The next “.@n::id2a” portion of the statement causes an XMLList object xmllist2 to be created with bXMLList set true and member [0] xml2 implicit XML object that refers to XML_ITEM #10 in the source XML_ITEM list. This may be logically equivalent to the statement xmllist1.@n::id2a. The xmllist2 XML object may be returned and assigned to the attr variable.

The document model described above may be destroyed through cleanup processing when the various explicit and implicit XML objects are destroyed. As each explicit or implicit XML object is destroyed a callback function may be called to handle cleanup. When less than the entire document model is requested for destruction the callback function may take no action. When an object's XML_INFO bXMLList member is set to true and the pHeadItem has oxnum equal to zero, no processing may occur by the callback function because the object is a previously processed implicit XML object. When neither of these conditions is satisfied the callback function may: set to zero the XML object's XML_INFO pHeadItem XML_ITEM oxnum, release the pPrologHead and pXltemHead lists of XML_ITEMs by calling a relXMLItems( ) helper function, release the XML_INFO structure.

Although the present disclosure and its advantages have been described in detail, it should be understood that various changes, substitutions and alterations can be made herein without departing from the spirit and scope of the disclosure as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the present invention, disclosure, machines, manufacture, compositions of matter, means, methods, or steps, presently existing or later to be developed that perform substantially the same function or achieve substantially the same result as the corresponding embodiments described herein may be utilized according to the present disclosure. Accordingly, the appended claims are intended to include within their scope such processes, machines, manufacture, compositions of matter, means, methods, or steps.

What is claimed is:

1. A method, comprising:
reading a markup language document;
parsing the markup language document; and
storing an in-memory document model document model of the markup language document.

2. The method of claim 1, in which storing the in-memory document model comprises storing a model of the markup language document in a linked list.

3. The method of claim 2, in which storing the document model in a linked list comprises:
storing each tag of the markup language document as a node in the linked list;
storing each element of each tag of the markup language document as a sub-node of a node corresponding to the tag in the linked list; and
storing each attribute of each tag of the markup language document as a sub-node of a node corresponding to the tag in the linked list.

4. The method of claim 3, in which storing each tag of the markup language document as a node in the linked list comprises:
estimating a string length for storing each tag; and
allocating from a memory pool storage corresponding to the estimated string length.

5. The method of claim 1, further comprising allocating a memory pool for storage of the in-memory document model before storing the markup language document in the in-memory document model.

6. The method of claim 1, in which the memory document model stores data and a structure of the markup language document.

7. The method of claim 1, in which reading the markup language document comprises reading at least one of a hypertext markup language (HTML) document, an extensible hypertext markup language document (XHTML), and an extensible markup language (XML) document.

8. A computer program product, comprising:
a computer-readable medium comprising:
code to read a markup language document;
code to parse the markup language document; and
code to store an in-memory document model of the markup language document.

9. The computer program product of claim 8, in which the code to store the markup language stores the markup language document in a linked list.

10. The computer program product of claim 9, in which the medium further comprises:
code to store each tag of the markup language document as a node in the linked list;
code to store each element of each tag of the markup language document as a sub-node of a node corresponding to the tag in the linked list; and
code to store each attribute of each tag of the markup language document as a sub-node of a node corresponding to the tag in the linked list.

11. The computer program product of claim 10, in which the medium further comprises:
code to estimate a string length for storing each tag; and
code to allocate memory from a memory pool corresponding to the estimated string length.

12. The computer program product of claim 8, in which the medium further comprises code to allocate a memory pool for storage of the in-memory document model.

13. The computer program product of claim 8, in which the medium further comprises code to store data and a structure of the markup language document.

14. The computer program product of claim 8, in which the code to parse parses at least one of a hypertext markup language (HTML) document, an extensible hypertext markup language document (XHTML), and an extensible markup language (XML) document.

15. An apparatus, comprising:
at least one processor and a memory coupled to the at least one processor, in which the at least one processor is configured:
to read a markup language document from the memory;
to parse the markup language document; and
to store an in-memory document model of the markup language document in the memory.

16. The apparatus of claim 15, in which the at least one processor is configured to store the markup language document in a linked list in the memory.

17. The apparatus of claim 16, in which the at least one processor is further configured:
to store each tag of the markup language document as a node in the linked list;
to store each element of each tag of the markup language document as a sub-node of a node corresponding to the tag in the linked list; and
to store each attribute of each tag of the markup language document as a sub-node of a node corresponding to the tag in the linked list.

18. The apparatus of claim 17, in which the at least one processor is further configured:
to estimate a string length for storing each tag; and
to allocate a portion of the memory to a node corresponding to the estimated string length.

19. The apparatus of claim 15, in which the at least one processor is further configured to allocate a memory pool in the memory for storage of the in-memory document model.

20. The apparatus of claim 15, in which the at least one processor is configured to parse at least one of a hypertext markup language (HTML) document, an extensible hypertext markup language document (XHTML), and an extensible markup language (XML) document.
